(19) United States
(12) Patent Application Publication
(10) Pub. No.: US 2023/0318348 A1
(43) Pub. Date: Oct. 5, 2023

(54) VEHICLE-POWER-GENERATOR CONTROL APPARATUS

(71) Applicant: Mitsubishi Electric Corporation, Tokyo (JP)

(72) Inventors: Eiki MATSUDA, Tokyo (JP); Junya Sasaki, Tokyo (JP); Hideyuki Imanaka, Tokyo (JP)

(73) Assignee: Mitsubishi Electric Corporation, Tokyo (JP)

(21) Appl. No.: 17/889,850

(22) Filed: Aug. 17, 2022

(30) Foreign Application Priority Data
Mar. 31, 2022 (JP) 2022-058538

(51) Int. Cl. H02J 7/16; B60R 16/023; H02J 7/00; H02P 23/14

(52) U.S. Cl. CPC H02J 7/16; B60R 16/0231; H02J 7/0047; H02J 7/00032; H02P 23/14

(57) ABSTRACT

When executing gradual excitation control, an excitation-current control unit controls an excitation current based on a gradual-excitation control signal from a gradual-excitation control unit, and when the gradual excitation control has been cancelled, the excitation-current control unit controls the excitation current based on a voltage control signal from a control-voltage comparison unit; the gradual-excitation control unit is configured in such a way as to be able to change gradual-excitation control methods in accordance with gradual-excitation-control setting information transmitted from an ECU.

### BACKGROUND OF THE INVENTION

### Field of the Invention

The present disclosure relates to a vehicle-power-generator control apparatus.

### Description of the Related Art

As is well known, with regard to gradual excitation control in a vehicle-power-generator control apparatus, various kinds of technologies have been proposed to date. For example, Patent Document 1 discloses a technology in which during the first gradual excitation control after a start of an internal combustion engine is detected, a masking means prohibits cancellation of the gradual excitation control. It is argued that because this conventional technology suppresses a sudden change in the load torque of a vehicle power generator that is produced when gradual excitation control is cancelled after the internal combustion engine starts, the internal combustion engine can be prevented from stopping.

In addition, Patent Document 2 discloses a technology in which during operation of an internal combustion engine and in a rotation zone where the rotation speed of the internal combustion engine is the same as or lower than a gradual-excitation cancellation rotation speed, when the increase rate of the rotation speed of the internal combustion engine is high, an aimed value is set to the one that is higher by a minute voltage than a target voltage value and a during-acceleration adjustment voltage that is delayed by a minute time is utilized. It is argued that this technology can suppress a fluctuation in the power-generator driving torque at a time when the increase rate of the rotation speed of the internal combustion engine is low.

Moreover, Patent Document 3 discloses a technology in which when there occurs a communication disruption state in which a communication frame to be transmitted from an external ECU (Electronic Control Unit) is not received for a time longer than a predetermined time, power-generation control is performed while the power-generation control value that has been set at that moment is made to gradually approach a predetermined default value. It is argued that because even when a communication disruption occurs, this conventional technology prevent the power-generation amount from drastically changing, no adverse effect is provided to the vehicle system and the feeling of discomfort can be prevented from being provided to the vehicle occupant.

### PRIOR ART REFERENCE

### Patent Document

[Patent Document 1] Japanese Patent Application Laid-Open No. 2006-271096
[Patent Document 2] Japanese Patent Application Laid-Open No. 2001-245441
[Patent Document 3] Japanese Patent Application Laid-Open No. 2011-229219

### SUMMARY OF THE INVENTION

Although each of the conventional technologies disclosed in Patent Documents 1 and 2 can suppress a load fluctuation in a vehicle, there exists a probability that a fluctuation in the battery voltage occurs and hence electric-power supply to on-vehicle electric apparatuses becomes insufficient. In addition, although the conventional technology disclosed in Patent Document 3 makes it possible that a gradual-excitation control time, a gradual-excitation cancellation rotation speed, and the like are set through communication with an external control apparatus, it is not made possible to adjust a detailed behavior of the gradual excitation control at a time when there occurs a transition from a value exceeding the gradual-excitation rotation speed to a value the same as or lower than the gradual-excitation cancellation rotation speed.

As described above, in the conventional technologies, it is required that when a vehicle-power-generator control apparatus is designed, it is preliminarily determined whether a gradual-excitation control method that emphasizes suppression of load fluctuation in a vehicle is adopted or a gradual-excitation control method that emphasizes suppression of fluctuation in a battery voltage is adopted; thus, there has been a problem that while a vehicle power generator is operated, the gradual-excitation control methods cannot be changed.

The present disclosure is to disclose a technology for solving the foregoing problems; the objective thereof is to provide a vehicle-power-generator control apparatus that makes it possible to change the gradual-excitation control methods while a vehicle power generator is operated.

A vehicle-power-generator control apparatus disclosed in the present application controls an output of a vehicle power generator for charging a battery mounted in a vehicle and includes

a voltage sensor that detects a voltage of the battery,

a control-voltage comparator that generates a voltage control signal, based on a comparison between a voltage of the battery detected by the voltage sensor and a preliminarily determined setting voltage,

a rotation speed sensor that detects a rotation speed of the vehicle power generator,

a gradual-excitation controller that sets a gradual-excitation control method for performing gradual excitation control of the vehicle power generator, based on a gradual-excitation time possessed by the vehicle-power-generator control apparatus and gradual-excitation-control setting information transmitted from an ECU provided outside the vehicle-power-generator control apparatus, and generates a gradual-excitation control signal based on the set gradual-excitation control method, and

an excitation-current controller that controls an excitation current of the vehicle power generator, based on any one of the voltage control signal generated by the control-voltage comparator and the gradual-excitation control signal generated by the gradual-excitation controller. The vehicle-power-generator control apparatus is characterized

in that when executing the gradual excitation control, the excitation-current controller controls an excitation current of the vehicle power generator, based on the gradual-excitation control signal, and when the gradual excitation control has been cancelled, the excitation-current controller controls an excitation current of the vehicle power generator, based on the voltage control signal, and

in that the gradual-excitation controller can change the gradual-excitation control methods in accordance with the gradual-excitation-control setting information transmitted from the ECU.

The present disclosure makes it possible to obtain a vehicle-power-generator control apparatus that can change gradual-excitation control methods while a vehicle power generator is operated.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a configuration diagram representing a vehicle-power-generator control apparatus according to Embodiment 1;

FIG. 2 is an explanatory chart representing the operation of gradual excitation control in the vehicle-power-generator control apparatus according to Embodiment 1;

FIG. 3 is an explanatory chart representing the operation, through a first gradual-excitation control method, of the vehicle-power-generator control apparatus according to Embodiment 1;

FIG. 4 is an explanatory chart representing the operation, thorough a second gradual-excitation control method, of the vehicle-power-generator control apparatus according to Embodiment 1;

FIG. 5 is a configuration diagram representing a vehicle-power-generator control apparatus that is a basis of the present disclosure.

FIG. 6 is an explanatory view illustrating an example of data-region configurations in communication frames to be transmitted or received between an ECU and the vehicle-power-generator control apparatus that is a basis of the present disclosure; and

FIG. 7 is an explanatory chart representing the operation of the vehicle-power-generator control apparatus that is a basis of the present disclosure.

### DETAILED DESCRIPTION OF THE PREFERRED EMBODIMENTS

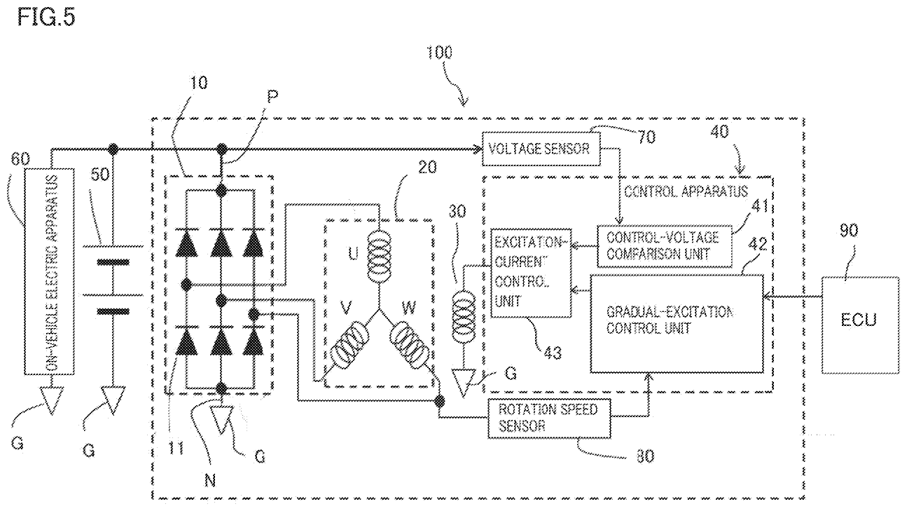

At first, a vehicle-power-generator control apparatus that is a basis of the present disclosure will be explained. FIG. 5 is a configuration diagram representing a vehicle-power-generator control apparatus that is a basis of the present disclosure. In FIG. 5, a vehicle-power-generator control apparatus 100 includes a three-phase full-wave rectifier 10, an armature coil 20 mounted in a stator, a magnetic-field coil 30 mounted in a rotor, a control apparatus 40 for controlling a voltage induced in the armature coil 20, a voltage sensor 70, and a rotation speed sensor 80.

The armature coil 20 includes a U-phase coil U, a V-phase coil V, and a W-phase coil W that are Y-connected. The three-phase full-wave rectifier 10 is formed of six semiconductor rectifiers 11 included in a three-phase bridge circuit. A U-phase input terminal, a V-phase input terminal, and a W-phase input terminal, which are AC terminals of the three-phase full-wave rectifier 10, are connected with a U-phase coil terminal, a V-phase coil terminal, and a W-phase coil terminal, respectively, in the armature coil 20.

A positive-polarity terminal P and a negative-polarity terminal N, which are DC terminals of the three-phase full-wave rectifier 10, are connected with the positive-polarity side of a battery 50 mounted in a vehicle and a ground potential portion G of the vehicle, respectively. An on-vehicle electric apparatus 60, which is a load on the battery 50, is connected between the positive-polarity side and the ground potential portion G.

The rotor of the vehicle power generator 100 is driven to rotate by an internal combustion engine (unillustrated) mounted in the vehicle, and hence the magnetic-field coil 30 mounted in the rotor rotates; accordingly, an AC voltage is induced in the armature coil 20 mounted in the stator. The AC voltage induced in the armature coil 20 is full-wave rectified to become a DC voltage by the three-phase full-wave rectifier 10; then, the battery 50 is charged with the DC voltage.

The control apparatus 40 is formed of an Integrated Circuit Voltage Regulator and includes a control-voltage comparison unit 41 as a control-voltage comparator, a gradual-excitation control unit 42 as a gradual-excitation controller, and an excitation-current control unit 43 as an excitation-current controller. The control-voltage comparison unit 41 compares a battery voltage detected by the voltage sensor 70 with a target voltage, which is a preliminarily set setting voltage; then, based on the difference, the control-voltage comparison unit 41 generates and outputs a voltage control signal for controlling an excitation current that flows in the magnetic-field coil 30.

The gradual-excitation control unit 42 is a control apparatus that performs gradual excitation in which when an excitation current as a magnetic-field current is changed, the excitation current is gradually changed; based on a gradual-excitation time preliminarily possessed by the vehicle-power-generator control apparatus 100 and gradual-excitation-control setting information transmitted from an ECU 90 provided outside the vehicle-power-generator control apparatus 100, the gradual-excitation control unit 42 generates and outputs a gradual-excitation control signal for controlling an excitation current that flows in the magnetic-field coil 30. The gradual-excitation control signal generated by the gradual-excitation control unit 42 is formed of a signal that determines an excitation-current ON rate to be applied to the excitation-current control unit 43. The excitation-current ON rate corresponds to a driving duty for a semiconductor switching device, such as a MOSFET (Metal-oxide Semiconductor Field-Effect Transistor), in the excitation-current control unit 43 and may be referred to as a power-generation rate.

In addition, as described later, the gradual-excitation control unit 42 executes or cancels gradual excitation control, based on the rotation speed of the power generator detected by the rotation speed sensor 80.

The excitation-current control unit 43 controls an excitation current, based on a control signal from the control-voltage comparison unit 41; however, when the output of the gradual-excitation control unit 42 is valid, the excitation-current control unit 43 performs gradual excitation control of an excitation current, based on the output of the gradual-excitation control unit 42. The excitation-current control unit 43 has, for example, a semiconductor switching device; based on the control signal from the control-voltage comparison unit 41, the excitation-current control unit 43 controls the excitation current by performing PWM (Pulse Width Modulation)-control of the semiconductor switching device and adjusts the AC voltage generated in the armature coil 20 so that the voltage of the battery 50 is controlled to be a constant value or a desired value.

In addition, while performing the gradual excitation control, the excitation-current control unit 43 executes gradual excitation control of the excitation current by performing PWM-control of the semiconductor switching device based on the excitation-current ON rate from the gradual-excitation control unit 42.

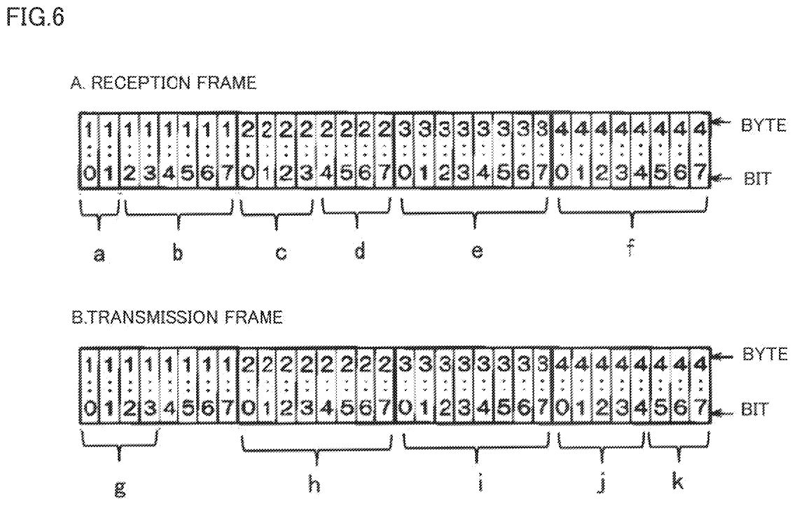

FIG. 6 is an explanatory view illustrating an example of data-region configurations in communication frames to be transmitted or received between an ECU and the vehicle-power-generator control apparatus that is a basis of the present disclosure; “A” represents a reception frame from the ECU 90 that is received by the gradual-excitation control unit 42; “B” represents a transmission frame that is transmitted from the gradual-excitation control unit 42 to the ECU 90.

In the reception frame represented by “A” in FIG. 6, “a” indicates a changing amount of the excitation-current ON rate, with which a change in the excitation current is permitted; “b” indicates a limit value as the upper limit value of the excitation-current ON rate; “c” indicates a gradual-excitation speed as a changing amount of the excitation-current ON rate per unit time in the gradual excitation control; “d” indicates a gradual-excitation cancellation rotation speed at which the gradual excitation control is cancelled; “e” indicates an adjustment voltage value at a time when the battery voltage is controlled to be constant; and “f” indicates an excitation-current upper limit value at a time when the excitation current is limited. These information items are included in the gradual-excitation-control setting information.

In addition, in the transmission frame represented by “B” in FIG. 6, “g”, “h”, “i”, “j”, and “k” are information items indicating the result of a diagnosis on whether or not an abnormality exists, performed by an abnormality detection circuit, an output voltage value of the vehicle power generator, an excitation current value, a driving duty, i.e., the excitation-current ON rate for the semiconductor switching device in the excitation-current control unit 43, and the voltage control output value, respectively.

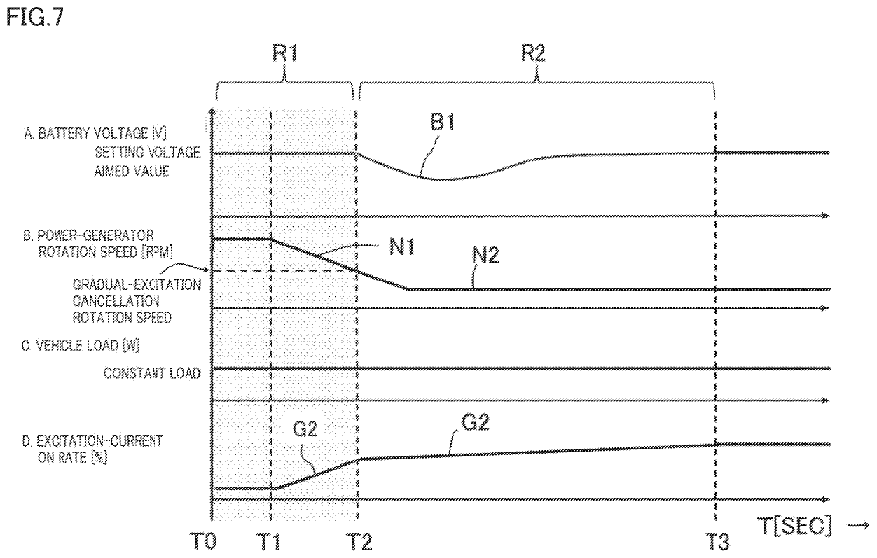

FIG. 7 is an explanatory chart representing the operation of the vehicle-power-generator control apparatus that is a basis of the present disclosure; “A”, “B”, “C”, “D”, and the abscissa denote the battery voltage [V], the power-generator rotation speed [RPM], the vehicle load [W], the excitation-current ON rate [%], and the time [SEC], respectively. The section between a time point T0 and a time point T2 is a gradual-excitation cancellation region R1, i.e., a region where the power-generator rotation speed is higher than the gradual-excitation cancellation rotation speed preliminarily set by the ECU 90. In the gradual-excitation cancellation region R1, the excitation-current control unit 43 controls the excitation current, based on the voltage control signal from the control-voltage comparison unit 41; when the power-generator rotation speed represented by “B” gradually falls from the time point T1, as indicated by N1, the excitation-current control unit 43 gradually raises the excitation-current ON rate represented by “D”, as indicated by G2, so that the supplied power to the on-vehicle electric apparatus 60 as the vehicle load represented by “C” is kept constant.

The section between the time point T2 and a time point T3 is a gradual-excitation-control execution region R2 where the gradual-excitation control unit 42 executes gradual excitation control; when the power-generator rotation speed represented by “B” becomes the same as or lower than the gradual-excitation cancellation rotation speed, excitation-current control based on the voltage control signal form the control-voltage comparison unit 41 is changed to the gradual excitation control based on the gradual-excitation control signal from the gradual-excitation control unit 42. In the gradual-excitation-control execution region R2, based on the gradual-excitation-control setting information from the ECU 90 and the gradual-excitation time possessed by the vehicle-power-generator control apparatus 100, the gradual excitation control is executed. When the gradual-excitation time elapses at the time point T3, the gradual excitation control is changed to the excitation-current control based on the voltage control signal from the control-voltage comparison unit 41 so that the vehicle power generator is controlled.

The foregoing explanation for the gradual excitation control in the vehicle-power-generator control apparatus that is a basis of the present disclosure is the one at a time when there is adopted a gradual-excitation control method in which suppression of a sudden change in the load torque of a vehicle power generator is emphasized. Accordingly, as represented in FIG. 7, even when in the gradual-excitation-control execution region R2, the power-generator rotation speed falls to N2, the excitation-current ON rate represented by “D” does not rapidly increase, as indicated by G2, due to the gradual excitation control; thus, the battery voltage represented by “A”, i.e., the output voltage of the power generator temporarily falls as indicated by B1.

As described above, due to the gradual-excitation-control setting information from the ECU 90, the gradual-excitation speed, as a changing amount of the excitation-current ON rate per unit time in the gradual excitation control, and the gradual-excitation cancellation rotation speed can be set; however, when the gradual-excitation cancellation region R1 where the power-generator rotation speed is higher than the gradual-excitation cancellation rotation speed is followed by the gradual-excitation-control execution region R2 where the power-generator rotation speed is the same as or lower than the gradual-excitation cancellation rotation speed, the detailed behavior of the gradual excitation control cannot be adjusted.

In other words, it is required that at a time of designing the vehicle-power-generator control apparatus, it is preliminarily set whether a gradual-excitation control method where suppression of a fluctuation of supplied power to the vehicle load is emphasized is adopted or a gradual-excitation control method where suppression of a fluctuation of the battery voltage is emphasized is adopted; therefore, the different gradual-excitation control methods cannot be utilized in accordance with the respective operating states of the internal combustion engine.

The vehicle-power-generator control apparatus according to Embodiment 1 of the present disclosure is the one in which a gradual-excitation control method where suppression of a fluctuation of supplied power to the vehicle load is emphasized and a gradual-excitation control method where suppression of a fluctuation of the battery voltage is emphasized can be changed in accordance with the gradual-excitation-control setting information from the ECU 90.

### Embodiment 1

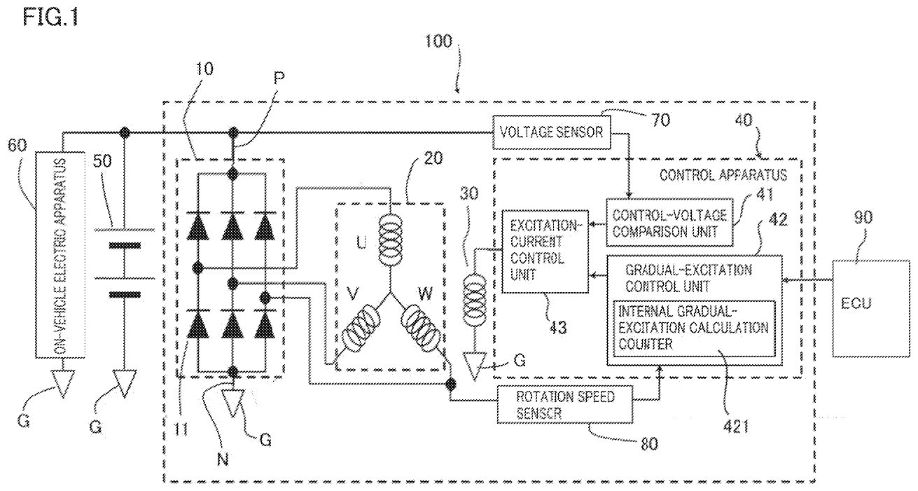

Hereinafter, a vehicle-power-generator control apparatus according to Embodiment 1 will be explained with reference to the drawings. FIG. 1 is a configuration diagram representing a vehicle-power-generator control apparatus according to Embodiment 1; the constituent elements the same as or similar to those of the vehicle-power-generator control apparatus that is a basis of the present disclosure are designated by reference characters the same as those therein. In the following explanation, the difference from the vehicle-power-generator control apparatus that is a basis of the present disclosure will mainly be explained.

In FIG. 1, the gradual-excitation control unit 42 is a control apparatus that performs gradual excitation in which when an excitation current as a magnetic-field current is changed, the excitation current is gradually changed; based on a gradual-excitation time preliminarily possessed by the vehicle-power-generator control apparatus 100 and gradual-excitation-control setting information transmitted from an ECU 90 provided outside the vehicle-power-generator control apparatus 100, the gradual-excitation control unit 42 generates and outputs a gradual-excitation control signal for controlling an excitation current that flows in the magnetic-field coil 30. The gradual-excitation control signal generated by the gradual-excitation control unit 42 is formed of a signal that determines an excitation-current ON rate to be applied to the excitation-current control unit 43. The excitation-current ON rate corresponds to a driving duty for a semiconductor switching device, such as a MOSFET (Metal-oxide Semiconductor Field-Effect Transistor), in the excitation-current control unit 43 and may be referred to as a power-generation rate.

In addition, as described later, the gradual-excitation control unit 42 executes or cancels gradual excitation control, based on the rotation speed of the vehicle power generator, detected by the rotation speed sensor 80. The respective configurations and contents of a reception frame and a transmission frame to be transmitted or received between the ECU 90 and the gradual-excitation control unit 42 are the same as those described in FIG. 6 and in the explanation therefor.

The gradual-excitation control unit 42 is provided with an internal gradual-excitation calculation counter 421. The internal gradual-excitation calculation counter 421 stores a tentative excitation-current ON rate, as a calculation setting value, that is different from the excitation-current ON rate to be applied to the excitation-current control unit 43 by the gradual-excitation control unit 42. The setting value of the excitation-current ON rate, stored in the internal gradual-excitation calculation counter 421, is utilized as the initial value for the gradual-excitation control unit 42 at a time when the excitation-current ON rate applied to the gradual-excitation control unit 42 increases.

As described later, the gradual-excitation control unit 42 has a function of changing a gradual-excitation time preliminarily possessed by the vehicle-power-generator control apparatus 100. As described later, with regard to the setting of the gradual excitation control in the gradual-excitation control unit 42, a command from the ECU makes it possible to utilize either a first gradual-excitation control method where suppression of a fluctuation of the vehicle load is emphasized or a second gradual-excitation control method where suppression of a fluctuation of the battery voltage is emphasized, in accordance with the gradual-excitation-control setting information transmitted from the ECU 90. In addition, the gradual-excitation-control setting information corresponds to the operating state of an internal combustion engine that drives the vehicle power generator. As described later, the gradual-excitation control unit 42 is configured in such a way as to be able to change the gradual-excitation control methods in accordance with the gradual-excitation-control setting information transmitted from the ECU 90.

Next, the operation of the vehicle-power-generator control apparatus according to Embodiment 1 will be explained. Based on the gradual-excitation-control setting information transmitted from the ECU 90 and the gradual-excitation time possessed by the vehicle-power-generator control apparatus 100, the gradual-excitation control unit 42 generates the gradual-excitation control signal. The gradual-excitation control signal is a signal corresponding to the excitation-current ON rate. The excitation-current control unit 43 is configured in the following manner: when executing the gradual excitation control, the excitation-current control unit 43 controls the excitation current of a vehicle power generator, based on the excitation-current ON rate as the gradual-excitation control signal from the gradual-excitation control unit 42; when the gradual excitation control has been cancelled, the excitation-current control unit 43 controls the excitation current of the vehicle power generator, based on the voltage control signal from the control-voltage comparison unit 41.

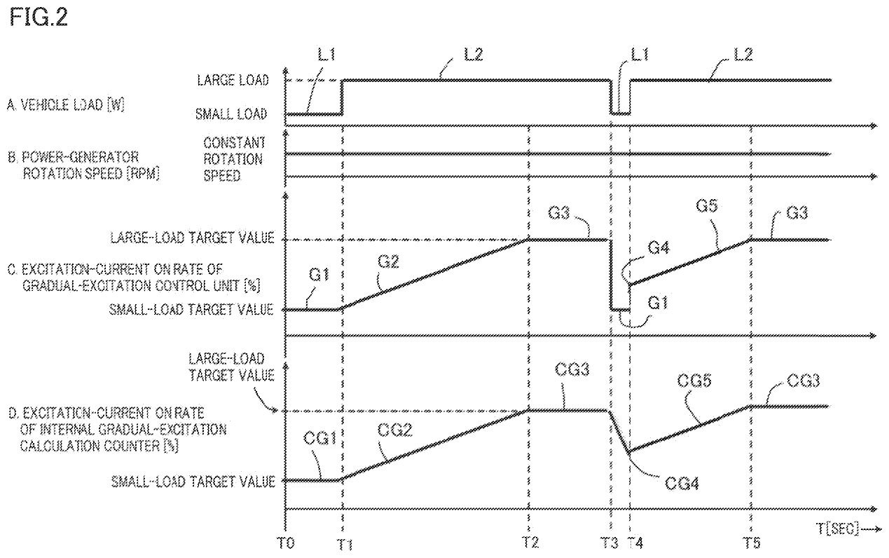

FIG. 2 is an explanatory chart representing the basic operation of the gradual excitation control in the vehicle-power-generator control apparatus according to Embodiment 1; FIG. 2 represents the operation at a time when the power-generator rotation speed is the same as or lower than the gradual-excitation cancellation rotation speed, i.e., the operation at a time when the gradual excitation control is executed. In FIG. 2, “A”, “B”, “C”, “D”, and the abscissa denote the vehicle load [W], the power-generator rotation speed [RPM], the excitation-current ON rate [%] that is applied to the excitation-current control unit 43 by the gradual-excitation control unit 42, the excitation-current ON rate [%] stored in the internal gradual-excitation calculation counter 421, and the time T [SEC], respectively.

In FIG. 2, in the section between a time point TO and a time point T1, the vehicle load represented by “A” is in the state of a small load L1; therefore, the excitation-current ON rate of the gradual-excitation control unit represented by “C” is held at an excitation-current ON rate G1 that coincides with the target value at a time of a small load. In the section between the time point T1 and a time point T3, because the vehicle load represented by “A” is in the state of a large load L2, the excitation-current ON rate of the gradual-excitation control unit represented by “C” becomes an excitation-current ON rate G2 that gradually increases from the time point T1 with the gradual-excitation time possessed by the vehicle-power-generator control apparatus 100; then, at a time point T2, the excitation-current ON rate reaches an excitation-current ON rate G3 that coincides with the target value at a time of a large load, and is held at the excitation-current ON rate G3 till the time point T3.

In the section between the time point TO and the time point T3, the excitation-current ON rate of the internal gradual-excitation calculation counter represented by “D” becomes excitation-current ON rates CG1, CG2, and CG3 in response to the excitation-current ON rates G1, G2, and G3, respectively, of the gradual-excitation control unit represented by “C”.

Next, in the section between the time point T3 and a time point T4, because the vehicle load represented by “A” is in the state of the small load L1, the excitation-current ON rate of the gradual-excitation control unit represented by “C” instantly falls at the time point T3 from the excitation-current ON rate G3 that coincides with the target value at a time of a large load to the excitation-current ON rate G1 that coincides with the target value at a time of a small load, and is held at the excitation-current ON rate G1 till the time point T4.

Based on a subtraction time of the internal gradual-excitation calculation counter 421, the excitation-current ON rate of the internal gradual-excitation calculation counter represented by “D” follows the instant change, at the time point T3, in the excitation-current ON rate of the gradual-excitation control unit so as to gradually falls from the time point T3, and then reaches an excitation-current ON rate CG4 at the time point T4. The excitation-current ON rate CG4 of the internal gradual-excitation calculation counter 421 at the time point T4 is a halfway-stage value following the excitation-current ON rate G1 of the gradual-excitation control unit 42 and is larger than the excitation-current ON rate G1 of the gradual-excitation control unit 42.

Because the vehicle load represented by “A” is in the state of the large load L2 from the time point T4, the excitation-current ON rate of the gradual-excitation control unit 42 represented by “C” starts to rise from the time point T4 and then instantly rises at the time point T4 to an excitation-current ON rate G4 that coincides with the excitation-current ON rate CG4 of the internal gradual-excitation calculation counter 421 at the time point 14; after that, the excitation-current ON rate of the gradual-excitation control unit becomes an excitation-current ON rate G5 that gradually increases with the gradual-excitation time possessed by the vehicle-power-generator control apparatus 100 and then becomes, at a time point T5, the excitation-current ON rate G3 that coincides with the target value at a time of a large load.

The excitation-current ON rate of the internal gradual-excitation calculation counter represented by “D” becomes an excitation-current ON rate CG5 that again gradually rises following the excitation-current ON rate of the gradual-excitation control unit from the time point T4, and then becomes, at the time point T5, the excitation-current ON rate CG3 that coincides with the target value at a time of a large load.

As described above, when starting to rise due to an increase in the vehicle load, the excitation-current ON rate to be applied to the excitation-current control unit 43 from the gradual-excitation control unit 42 instantly rises, at that time point, to the value of the excitation-current ON rate of the internal gradual-excitation calculation counter 421 and then gradually rises to the target value from the foregoing value.

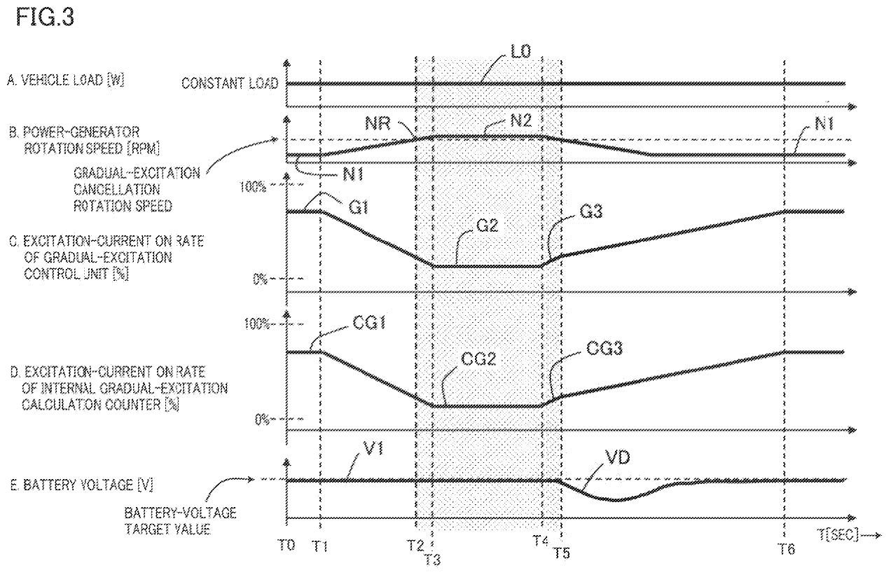

FIG. 3 is an explanatory chart representing the operation, through the first gradual-excitation control method, of the vehicle-power-generator control apparatus according to Embodiment 1. In this situation, as described above, in the vehicle-power-generator control apparatus according to Embodiment 1, the first gradual-excitation control method signifies a control method that emphasizes the vehicle load; it is emphasized that electric power is stably supplied to the on-vehicle electric apparatus 60 as the vehicle load.

In FIG. 3, “A”, “B”, “C”, “D”, “E”, and the abscissa denote the vehicle load [W], the power-generator rotation speed [RPM], the excitation-current ON rate [%] of the gradual-excitation control unit, the excitation-current ON rate [%] of the internal gradual-excitation calculation counter, the battery voltage [V], and the time T [SEC], respectively.

In FIG. 3, the power-generator rotation speed represented by “B” is constant in the section between a time point TO and a time point T1; however, it starts to rise from the time point T1 and reaches a gradual-excitation cancellation rotation speed NR at a time point T2. The power-generator rotation speed starts to rise from the time point T1. In this situation, in the section between the time point T1 and the time point T2, because the power-generator rotation speed represented by “B” has not reached the gradual-excitation cancellation rotation speed NR, the gradual excitation control is executed, and the excitation-current ON rate of the gradual-excitation control unit 42 represented by “C” starts to fall from the excitation-current ON rate G1 at the time point T1.

The excitation-current ON rate of the gradual-excitation control unit represented by “C” continues falling even after the power-generator rotation speed has reached the gradual-excitation cancellation rotation speed NR and then reaches the excitation-current ON rate G2 at a time point T3 when the power-generator rotation speed stabilizes at N2; then, the gradual excitation control is cancelled. From the time point T3, the excitation-current control unit 43 controls the excitation current, based on the voltage control signal from the control-voltage comparison unit 41.

The excitation-current ON rate of the internal gradual-excitation calculation counter represented by “D” follows the excitation-current ON rate of the gradual-excitation control unit represented by “C” so as to start to fall, at the time point T1, from the excitation-current ON rates CG1 that has continued till then; after that, the excitation-current ON rate of the internal gradual-excitation calculation counter represented by “D” reaches the excitation-current ON rate CG2 at the time point T3.

At a time point T4, the power-generator rotation speed represented by “B” starts to fall; however, although the power-generator rotation speed falls, the excitation-current ON rate of the gradual-excitation control unit represented by “C” immediately rises as G3 in response to the fall of the power-generator rotation speed so that at each power-generator rotation speed during the falling, the battery voltage represented by “E” is maintained at the battery-voltage target value. In contrast, the excitation-current ON rate of the internal gradual-excitation calculation counter represented by “D” completely follows the excitation-current ON rate of the gradual-excitation control unit so as to rise as CG3.

Next, at a time point T5, because the power-generator rotation speed represented by “B” becomes the same as or lower than the gradual-excitation cancellation rotation speed NR, the vehicle-power-generator control apparatus 100 executes the gradual excitation control; from the time point T5, the excitation-current ON rate of the gradual-excitation control unit represented by “C” is determined based on the gradual-excitation time possessed by the vehicle-power-generator control apparatus 100 and the gradual-excitation-control setting information transmitted from the ECU 90. Accordingly, the fall of the power-generator rotation speed represented by “B” causes a fall VD of the battery voltage; however, because causing no drastic increase in the excitation-current ON rate of the gradual-excitation control unit, the fall VD hardly or slightly affects the vehicle load represented by “A”.

After that, at a time point T6, the gradual-excitation time elapses and hence the gradual excitation control is cancelled; then, the excitation-current ON rate of the gradual-excitation control unit represented by “C” reaches G1. From the time point T6, based on the voltage control signal from the control-voltage comparison unit 41, the excitation-current control unit 43 controls the excitation current so that stable power generation with the preliminarily determined power-generator rotation speed N1 is performed in such a way that the battery voltage becomes a battery voltage V1 that coincides with the battery-voltage target value.

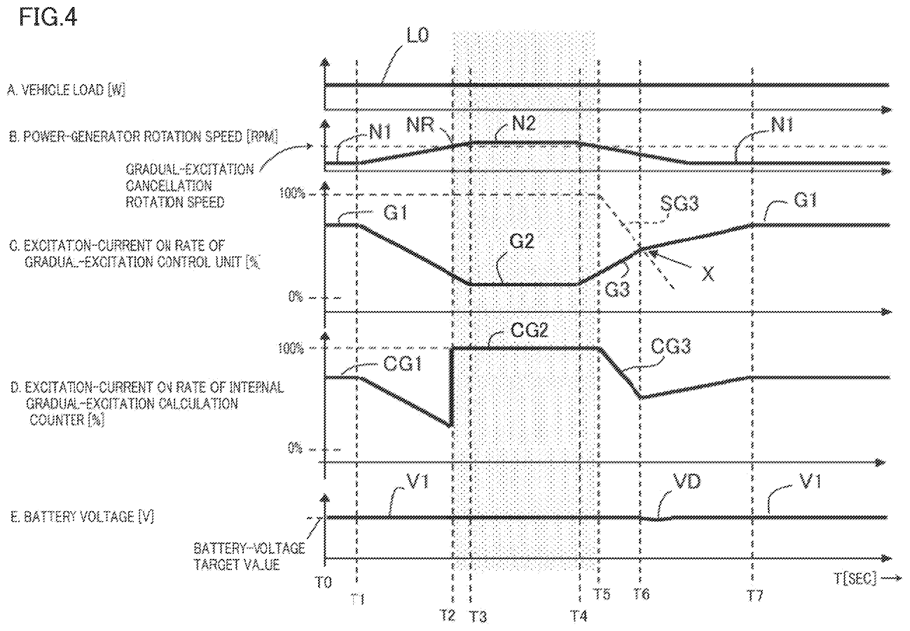

FIG. 4 is an explanatory chart representing the operation, through the second gradual-excitation control method, of the vehicle-power-generator control apparatus according to Embodiment 1. In this situation, in the vehicle-power-generator control apparatus according to Embodiment 1, the second gradual-excitation control method signifies a gradual-excitation control method that emphasizes the battery voltage; stabilization of the battery voltage is emphasized.

In FIG. 4, “A”, “B”, “C”, “D”, “E”, and the abscissa denote the vehicle load [W], the power-generator rotation speed [RPM], the excitation-current ON rate [%] of the gradual-excitation control unit, the excitation-current ON rate [%] of the internal gradual-excitation calculation counter, the battery voltage [V], and the time T [SEC], respectively.

In FIG. 4, the power-generator rotation speed represented by “B” is constant in the section between a time point TO and a time point T1; however, it starts to rise from the time point T1 and reaches the gradual-excitation cancellation rotation speed NR at a time point T2. Because the power-generator rotation speed starts to rise from the time point T1, the excitation-current ON rate of the gradual-excitation control unit 42 represented by “C” starts to fall from the excitation-current ON rate G1 at the time point T1. In this situation, in the section between the time point T1 and the time point T2, because the power-generator rotation speed represented by “B” has not reached the gradual-excitation cancellation rotation speed NR, the gradual excitation control is executed.

The excitation-current ON rate of the gradual-excitation control unit represented by “C” continues falling even after the power-generator rotation speed has reached the gradual-excitation cancellation rotation speed NR and then reaches the excitation-current ON rate G2 at a time point T3 when the power-generator rotation speed stabilizes at N2; then, the gradual excitation control is cancelled. From the time point T3, the excitation-current control unit 43 controls the excitation current, based on the voltage control signal from the control-voltage comparison unit 41.

The excitation-current ON rate of the internal gradual-excitation calculation counter represented by “D” follows the excitation-current ON rate of the gradual-excitation control unit represented by “C”; however, in the section between the time point T2 and a time point T5, in which the power-generator rotation speed represented by “B” becomes the same as or higher than the gradual-excitation cancellation rotation speed NR, the excitation-current ON rate of the internal gradual-excitation calculation counter is set to the excitation-current ON rate CG2, which is constantly 100 [%]. From a time point T4, the power-generator rotation speed represented by “B” starts to fall and further continues falling even after reaching the gradual-excitation cancellation rotation speed NR at the time point T5.

Although the power-generator rotation speed falls, the excitation-current ON rate of the gradual-excitation control unit represented by “C” immediately responds to the fall of the power-generator rotation speed and then rises, as the excitation-current ON rate G3 of the gradual-excitation control unit, from the time point T4 so that at each power-generator rotation speed during the falling, the power generation for a voltage of the battery-voltage target value can be performed.

Because at the time point 15, the power-generator rotation speed becomes the same as or lower than the gradual-excitation cancellation rotation speed NR, the excitation-current ON rate of the internal gradual-excitation calculation counter represented by “D” starts to fall, as SG3, from the excitation-current ON rate CG2 of 100 [%] that has continued till then; after that, at a time point T6, the excitation-current ON rate of the internal gradual-excitation calculation counter becomes a value the same as the excitation-current ON rate G3 of the gradual-excitation control unit 42. The character “X” in the excitation-current ON rate of the gradual-excitation control unit represented by “C” denotes an intersection point where the respective values of the excitation-current ON rate G3 of the gradual-excitation control unit and the excitation-current ON rate CG3 of the internal gradual-excitation calculation counter are equal to each other.

In the case where as described in FIG. 3, the vehicle load is emphasized, the gradual-excitation control unit 42 executes the gradual excitation control, when the power-generator rotation speed represented by “A” becomes gradual-excitation cancellation rotation speed NR at the time point T5 in FIG. 3, and hence the excitation-current ON rate of the gradual-excitation control unit represented by “C” gradually rises; however, in the case where as in FIG. 4, the battery voltage is emphasized, even when at the time point T5 in FIG. 4, the power-generator rotation speed represented by “B” becomes the gradual-excitation cancellation rotation speed NR, it is permitted that the excitation-current ON rate G3 of the gradual-excitation control unit rises in response to the fall of the power-generator rotation speed, as long as the excitation-current ON rate G3 of the gradual-excitation control unit represented by “C” is the same as or smaller than the excitation-current ON rate CG3 of the internal gradual-excitation calculation counter represented by “D”, i.e., in a time between the time point T5 and the time point T6, so that at each power-generator rotation speed during the falling of the power-generator rotation speed represented by “B”, the power generation for a voltage of the battery-voltage target value can be performed.

Accordingly, in the section between the time point T4 and the time point T6, even when the power-generator rotation speed falls, the battery voltage represented by “E” does not fall; however, because in this section, the gradual excitation control is not executed, the vehicle load represented by “A” is largely affected. However, the effect to the vehicle load can largely be changed by adjusting the subtraction time of the internal gradual-excitation calculation counter represented by “D”.

Based on the subtraction time set through the foregoing gradual-excitation control setting, the excitation-current ON rate of the internal gradual-excitation calculation counter represented by “D” continues to fall from the time point T5 when the power-generator rotation speed becomes the same as or lower than the gradual-excitation cancellation rotation speed NR to the time point T6 when the excitation-current ON rate of the internal gradual-excitation calculation counter becomes a value the same as the excitation-current ON rate G3 of the gradual-excitation control unit represented by “C”.

After the time point T5 when the excitation-current ON rate of the internal gradual-excitation calculation counter represented by “D” becomes equal to the excitation-current ON rate of the gradual-excitation control unit represented by “C”, the gradual excitation control based on the excitation-current ON rate of the gradual-excitation control unit represented by “C” is executed, based on the gradual-excitation time possessed by the vehicle-power-generator control apparatus 100. At a time point T7, the gradual-excitation time elapses and hence the gradual excitation control is cancelled; then, the excitation-current ON rate of the gradual-excitation control unit represented by “C” reaches G1. From the time point T7, based on the voltage control signal from the control-voltage comparison unit 41, the excitation-current control unit 43 controls the excitation current so that stable power generation with the preliminarily determined power-generator rotation speed N1 is performed in such a way that the battery voltage becomes a battery voltage V1 that coincides with the battery-voltage target value.

In the case of the gradual excitation control in FIG. 4 in which the battery voltage is emphasized, because there exists a temporal margin between the time point T5 when power-generator rotation speed becomes the same as or lower than the gradual-excitation cancellation rotation speed NR and the time point T6 when the gradual excitation control is executed, the fall VD of the battery voltage represented by “E” is small.

The vehicle-power-generator control apparatus according to Embodiment 1 can change the first gradual-excitation control method represented in foregoing FIG. 3 and the second gradual-excitation control method represented in foregoing FIG. 4, in according with the gradual-excitation-control setting information from the external ECU 90.

The gradual-excitation-control setting information from the external ECU 90 includes gradual-excitation-control changing information; for example, the external ECU 90 provides the gradual-excitation-control changing information to the vehicle-power-generator control apparatus 100 by use of a LIN (Local Interconnect Network) communication line.

Alternatively, the external ECU 90 provides the gradual-excitation-control changing information to the vehicle-power-generator control apparatus 100 by use of one or a plurality of communication lines and high-level and low-level signals.

Moreover, as another example, the external ECU 90 provides the gradual-excitation-control changing information to the vehicle-power-generator control apparatus 100 by use of one or a plurality of communication lines and a PWM (Pulse Width Modulation) signal.

Moreover, as another example, the external ECU 90 provides the gradual-excitation-control changing information to the vehicle-power-generator control apparatus 100 by use of a frequency modulation signal.

As a further another example, the external ECU 90 provides the gradual-excitation-control changing information to the vehicle-power-generator control apparatus 100 by use of one or a plurality of communication lines and an ON/OFF modulation signal.

The foregoing gradual-excitation control method is configured in such away that in the case where the rotation speed of the vehicle power generator detected by the rotation speed sensor 80 changes from a value exceeding the gradual-excitation cancellation rotation speed at which the gradual excitation is cancelled to a value the same as or lower than the gradual-excitation cancellation rotation speed, any one of the first gradual-excitation control method where the foregoing gradual-excitation time possessed by the vehicle-power-generator control apparatus 100 is immediately reflected at the foregoing changing time point and the second gradual-excitation control method where the foregoing possessed gradual-excitation time is reflected after a delay time from the foregoing changing time point is changed over to the other one, in accordance with the gradual-excitation-control setting information transmitted from the external ECU 90.

Although the present application is described above in terms of various exemplary embodiments and implementations, it should be understood that the various features, aspects and functions described in one or more of the individual embodiments are not limited in their applicability to the particular embodiment with which they are described, but instead can be applied, alone or in various combinations to one or more of the embodiments. Therefore, an infinite number of unexemplified variant examples are conceivable within the range of the technology disclosed in the present application. For example, there are included the cases where at least one constituent element is modified, added, or omitted.

What is claimed is:

1. A vehicle-power-generator control apparatus for controlling an output of a vehicle power generator that charges a battery mounted in a vehicle, the vehicle-power-generator control apparatus comprising:
a voltage sensor that detects a voltage of the battery;
a control-voltage comparator that generates a voltage control signal, based on a comparison between a voltage of the battery detected by the voltage sensor and a preliminarily determined setting voltage;
a rotation speed sensor that detects a rotation speed of the vehicle power generator;
a gradual-excitation controller that sets a gradual-excitation control method for performing gradual excitation control of the vehicle power generator, based on a gradual-excitation time possessed by the vehicle-power-generator control apparatus and gradual-excitation-control setting information transmitted from an ECU provided outside the vehicle-power-generator control apparatus, and generates a gradual-excitation control signal based on the set gradual-excitation control method; and
an excitation-current controller that controls an excitation current of the vehicle power generator, based on any one of the voltage control signal generated by the control-voltage comparator and the gradual-excitation control signal generated by the gradual-excitation controller,
wherein when executing the gradual excitation control, the excitation-current controller controls an excitation current of the vehicle power generator, based on the gradual-excitation control signal, and when the gradual excitation control has been cancelled, the excitation-current controller controls an excitation current of the vehicle power generator, based on the voltage control signal, and
wherein the gradual-excitation controller can change the gradual-excitation control methods in accordance with the gradual-excitation-control setting information transmitted from the ECU.

2. The vehicle-power-generator control apparatus according to claim 1, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

3. The vehicle-power-generator control apparatus according to claim 2, wherein the delay time can be changed based on the gradual-excitation-control setting information transmitted from the ECU.

4. The vehicle-power-generator control apparatus according to claim 1, wherein the gradual-excitation-control setting information includes information for changing the gradual-excitation control methods and is transmitted from the ECU by use of a LIN communication line.

5. The vehicle-power-generator control apparatus according to claim 4, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

6. The vehicle-power-generator control apparatus according to claim 5, wherein the delay time can be changed based on the gradual-excitation-control setting information transmitted from the ECU.

7. The vehicle-power-generator control apparatus according to claim 1, wherein the gradual-excitation control methods are changed based on high-level and low-level signals transmitted from the ECU by use of one or a plurality of communication lines.

8. The vehicle-power-generator control apparatus according to claim 7, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

9. The vehicle-power-generator control apparatus according to claim 8 wherein the delay time can be changed based on the gradual-excitation-control setting information transmitted from the ECU.

10. The vehicle-power-generator control apparatus according to claim 1, wherein the gradual-excitation control methods are changed based on a PWM signal transmitted from the ECU by use of one or a plurality of communication lines.

11. The vehicle-power-generator control apparatus according to claim 10, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

12. The vehicle-power-generator control apparatus according to claim 11, wherein the delay time can be changed based on the gradual-excitation-control setting information transmitted from the ECU.

13. The vehicle-power-generator control apparatus according to claim 1, wherein the gradual-excitation control methods are changed based on a frequency modulation signal transmitted from the ECU by use of one or a plurality of communication lines.

14. The vehicle-power-generator control apparatus according to claim 13, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

15. The vehicle-power-generator control apparatus according to claim 14, wherein the delay time can be changed based on the gradual-excitation-control setting information transmitted from the ECU.

16. The vehicle-power-generator control apparatus according to claim 1, wherein the gradual-excitation control methods are changed based on an ON/OFF modulation signal transmitted from the ECU by use of one or a plurality of communication lines.

17. The vehicle-power-generator control apparatus according to claim 16, wherein the gradual-excitation control method is configured in such a way that in the case where the rotation speed of the vehicle power generator detected by the rotation speed sensor changes from a value exceeding a gradual-excitation cancellation rotation speed at which gradual excitation is cancelled to a value the same as or lower than the gradual-excitation cancellation rotation speed, any one of a first gradual-excitation control method where the possessed gradual-excitation time is immediately reflected at the changing time point and a second gradual-excitation control method where the possessed gradual-excitation time is reflected after a delay time from the changing time point is changed over to the other one, in accordance with the gradual-excitation-control setting information transmitted from the ECU.

18. The vehicle-power-generator control apparatus according to claim 17, wherein the delay time can be changed based on the gradual-excitation-control setting information transmitted from the ECU.
